(19) United States
(12) Patent Application Publication
(10) Pub. No.: US 2010/0245295 A1
(43) Pub. Date: Sep. 30, 2010

(54) Operation input device, operation input method, and program

(75) Inventor: Takafumi Kimpara, Tokyo (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/661,641

(22) Filed: Mar. 22, 2010

(30) Foreign Application Priority Data
Mar. 31, 2009 (JP) P2009-087096

(51) Int. Cl. G06F 3/042

(52) U.S. Cl. 345/179

(57) ABSTRACT

An operation input device includes: input and output means for detecting light corresponding to a plurality of operation inputs to a display screen displaying an image from an outside; target generating means for generating information of a target indicating a series of inputs on the basis of a temporal or spatial positional relation of input portions having been subjected to the input from the outside; lost data holding means for holding a lost target when the target generated by the target generating means is temporarily lost; unreliable data deleting means for deleting an unstable target when the unstable target is generated by the target generating means; and process selecting means for selecting one of a process performed by the lost data holding means and a process performed by the unreliable data deleting means.

### CROSS-REFERENCE TO RELATED APPLICATION

The present application claims priority from Japanese Patent Application No. JP 2009-087096 filed in the Japanese Patent Office on Mar. 31, 2009, the entire content of which is incorporated herein by reference.

### BACKGROUND OF THE INVENTION

1. Field of the Invention

The present invention relates to an operation input device, an operation input method, and a program, and more particularly, to an operation input device, an operation input method, and a program, which can accurately operation in response to an operation input.

2. Description of the Related Art

For example, a display panel (hereinafter, also referred to as “input and output panel”) capable of being subjected to an input using light by disposing an optical sensor in a liquid crystal display and detecting an input of light from the outside with the optical sensor was suggested as a panel capable of outputting information on plural points on the panel (for example, JP-A-2008-146165).

The past input and output panel will be described below with reference to FIG. 1.

The input and output panel 11 shown in FIG. 1 includes an input and output display 12, a received-light signal processor 13, an image processor 14, a generator 15, and a controller 16.

The input and output display 12 displays an image and detects light corresponding to an input from the outside. For example, the input and output display 12 includes plural optical sensors 12A disposed to be distributed on the entire display screen, and the optical sensors 12A receive light incident from the outside, generates a received-light signal corresponding to the intensity of the received light, and supplies the generated received-light signal to the received-light signal processor 13.

The received-light signal processor 13 generates an image corresponding to the brightness of the received-light signal by performing a predetermined process on the received-light signal supplied from the input and output display 12 and supplies the generated image to the image processor 14.

The image processor 14 detects a portion on the display screen of the input and output display 12, which comes in contact with an object such as a user's finger, as an input portion having been subjected to an external input by performing a predetermined image process on the image supplied from the received-light signal processor 13. The image processor 14 generates coordinates of an input position, a contact area of the input portion, and a shape (contact region) of the input portion as dot information of the input portion and supplies the generated dot information to the generator 15.

The generator 15 includes a target generator 17 and a memory unit 18 and target information output per frame from the target generator 17 is stored in the memory unit 18. The target generator 17 generates the target information by synthesizing the dot information of the input portion supplied from the image processor 14 and the target information of the entirety of the frames stored in the memory unit 18 per frame. The target information is information in which IDs indicating a series of inputs are assigned to the input portions on the basis of a temporal or spatial positional relation of the input portions.

The controller 16 changes the display status of the input and output display 12 by controlling image data supplied from the input and output display 12 as needed on the basis of the target information generated by the generator 15.

However, in the past input and output display 12, dot information on a portion of the input and output display 12 not having come in contact with the object may be generated due to a temporal or spatial variation in light applied to the surface of the input and output display 12, which results from a variation in luminance of surrounding environment light or a temporary application of light with high luminance from a light-emitting device such as a flash. For example, when the luminance varies while a finger is moving at a position apart from the input and output display 12, an end of the shadow of the finger is generated as the dot information. Since a higher-level application program reacts to the dot information generated from the non-contact portion in the same way as the contact portion, an erroneous recognition may occur.

For example, when an incomplete reflector (an object not completely blocking light but slightly transmitting the light) such as a finger comes in contact and the temporal or spatial variation in light applied to the surface of the input and output display 12 occurs, the dot information of the contact portion may temporarily disappear. The generator 15 having received such dot information generates target information to which different IDs are assigned in the frame before and after the dot information is lost. Accordingly, for example, when a sudden variation in external light occurs during a series of contacts with a finger, the dot information disappears due to the sudden variation in external light, two times of contact with the finger are recognized in the next target process, and thus an error may occur in a higher-level application program.

### SUMMARY OF THE INVENTION

As described above, in the past input and output panel, dot information may be generated in a non-contact portion and dot information may be temporarily lost due to a variation in applied light. When the higher-level application program performs processes on the basis of the target information generated on the basis of the dot information, an error occurs. That is, an accurate operation may not be performed in response to an operation input.

Thus, it is desirable to accurately operate in response to an operation input.

According to an embodiment of the invention, there is provided an operation input device including: input and output means for detecting light corresponding to a plurality of operation inputs to a display screen displaying an image from an outside; target generating means for generating information of a target indicating a series of inputs on the basis of a temporal or spatial positional relation of input portions having been subjected to the input from the outside; lost data holding means for holding a lost target when the target generated by the target generating means is temporarily lost; unreliable data deleting means for deleting an unstable target when the unstable target is generated by the target generating means; and process selecting means for selecting one of a process performed by the lost data holding means and a process performed by the unreliable data deleting means.

According to another embodiment of the invention, there is provided an operation input method or a program causing a computer to execute the operation input method, the operation input method including the steps of: detecting light corresponding to a plurality of operation inputs to a display screen displaying an image from an outside; generating information of a target indicating a series of inputs on the basis of a temporal or spatial positional relation of input portions having been subjected to the input from the outside; holding a lost target when the generated target is temporarily lost; deleting an unstable target when the unstable target is generated; and selecting one of the process of holding the target and the process of deleting the unstable target.

In the embodiments of the invention, light corresponding to a plurality of operation inputs to the display screen from the outside is detected from the display screen displaying an image, and the information of a target indicating a series of inputs is generated on the basis of a temporal or spatial positional relation of input portions having been subjected to the input from the outside. A lost target is held when the generated target is temporarily lost and an unstable target is deleted when the unstable target is generated. One of the process of holding the target and the process of deleting the unstable target is selected.

According to the embodiments of the invention, it is possible to accurately operate in response to the operation input.

### BRIEF DESCRIPTION OF THE DRAWINGS

FIG. 1 is a block diagram illustrating a configuration of a past input and output panel.

FIG. 2 is a block diagram illustrating a configuration of an operation input device according to a first embodiment of the invention.

FIG. 3 is a flowchart illustrating a process of controlling a display of the operation input device.

FIG. 4 is a flowchart illustrating a noise deleting process.

FIG. 5 is a flowchart illustrating an abnormal high-density filtering process.

FIG. 6 is a flowchart illustrating an abnormal low-density filtering process.

FIG. 7 is a flowchart illustrating an abnormal aspect-ratio filtering process.

FIG. 8 is a flowchart illustrating a target correcting process.

FIG. 9 is a flowchart illustrating an unreliable data deleting process.

FIG. 10 is a flowchart illustrating a lost data holding process.

FIG. 11 is a diagram illustrating an operation of a corrector.

FIG. 12 is a diagram illustrating the operation of the corrector.

FIG. 13 is a diagram illustrating the operation of the corrector.

FIG. 14 is a block diagram illustrating a configuration of an operation input device according to a second embodiment of the invention.

FIG. 15 is a flowchart illustrating a target correcting process in the operation input device.

FIG. 16 is a block diagram illustrating a configuration of an operation input device according to a third embodiment of the invention.

FIG. 17 is a diagram illustrating a table in which representative luminance and set values of parameters are registered.

FIG. 18 is a block diagram illustrating a configuration of a computer.

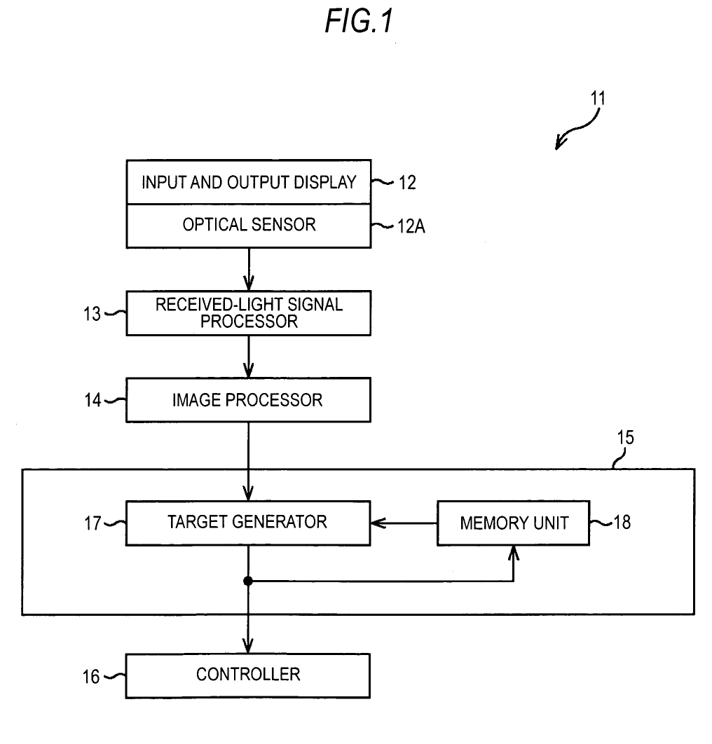

### DESCRIPTION OF THE PREFERRED EMBODIMENTS

Hereinafter, specific embodiments of the invention will be described in detail with reference to the accompanying drawings.

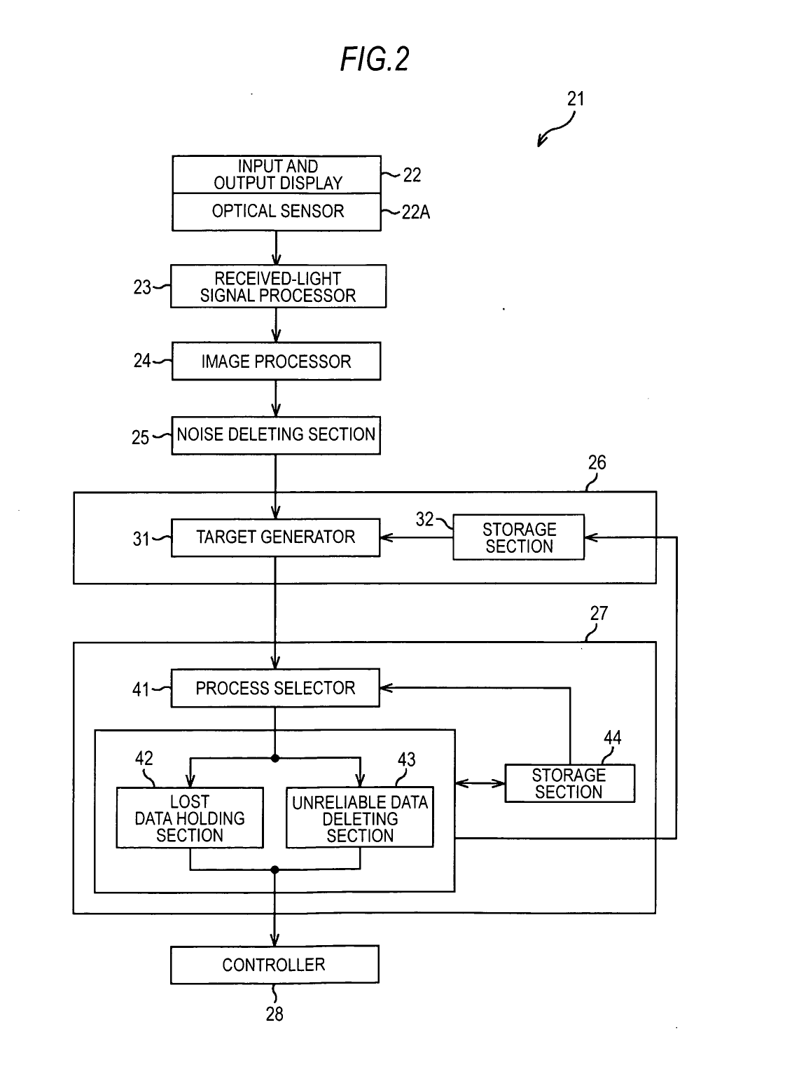

FIG. 2 is a block diagram illustrating a configuration of an operation input device according to a first embodiment of the invention.

In FIG. 2, an operation input device 21 includes an input and output display 22, a received-light signal processor 23, an image processor 24, a noise deleting section 25, a generator 26, a corrector 27, and a controller 28.

The input and output display 22 displays an image and detects light corresponding to an external input. That is, the input and output display 22 displays an image corresponding to image data supplied from a display signal processor not shown on its display screen. An input and output display 22 includes plural optical sensors 22A distributed over the entire display screen, receives light incident from the outside, generates a received-light signal corresponding to the intensity of the received light, and the generated received-light signal to the received-light signal processor 23.

The received-light signal processor 23 generates an image having a difference in brightness between a portion coming in contact with an object such as a user's finger and a portion coming in contact with nothing on the display screen of the input and output display 22 by performing a predetermined process on the received-light signal from the input and output display 22. The portion coming in contact with the object such as the user's finger includes a portion so close thereto that it can be determined that the object such as the user's finger almost comes in contact therewith. The received-light signal processor 23 generates an image having different brightness depending on the contact with the user's finger frame by frame of the image displayed on the display screen of the input and output display 22 and supplies the generated image to the image processor 24.

The image processor 24 performs image processes such as binarization, noise deletion, and labeling on the images of the frames supplied from the received-light signal processor 23. Accordingly, the image processor 24 detects the portion (region) on the display screen of the input and output display coming in contact with the user's finger as an input portion having been subjected to an external input, generates dot information of the input portion, and supplies the generated dot information to the noise deleting section 25. The dot information of the input portion includes coordinates (coordinates indicating a dot on the display screen of the input and output display 22 representing the input portion) of the input portion, the contact area of the input portion, and the shape (contact region) of the input portion.

The noise deleting section 25 performs a noise deleting process of deleting a noise component on the basis of the dot information of the input portion supplied from the image processor 24.

As described above, the image processor 24 detects the input portion on the basis of the image generated from the received-light signal output from the input and output display 22. In addition to the input portion resulting from the contact with the user's finger, an input portion resulting from a sudden variation of light applied to the display screen of the input and output display 22 but not coming in contact with the user's finger may be detected as the input portion by the image processor 24. Accordingly, the noise deleting section 25 performs a noise deleting process of recognizing the input portion detected from the portion not coming in contact with the object as a noise component by extracting the features of the shape and the like thereof and deleting the dot information of the input portion recognized as the noise component.

The generator 26 includes a target generator 31 and a storage section 32.

The target generator 31 is supplied with the dot information of the input portion from which the noise component is deleted by the noise deleting section 25. The target generator 31 synthesizes the dot information of the input portion and target-generation reference data of the entire frames stored in the storage section 32 frame by frame. By this synthesizing process, the target generator 31 generates target information to which target IDs for identifying the targets indicating a series of inputs are assigned on the basis of the temporal or spatial positional relations of the input portions.

The target-generation reference data referred to by the target generator 31 at the time of generating the target information is supplied to and stored in the storage section 32, as described later, from the corrector 27.

The corrector 27 corrects the target causing an erroneous operation by deleting an unstable target from the target information generated by the target generator 31 or holding a temporarily lost target. Then, the corrector 27 supplies the corrected target information to the controller 28.

That is, the corrector 27 includes a process selector 41, a lost data holding section 42, an unreliable data deleting section 43, and a storage section 44.

The process selector 41 selects a process to be performed on the targets on the basis of the target information supplied from the target generator 31 and the intermediate data stored in the storage section 44. The process selector 41 supplies the target information to one of the lost data holding section 42 and the unreliable data deleting section 43 depending on the process to be performed on the targets.

The lost data holding section 42 performs a lost data holding process of holding a temporarily lost target and reproducing the temporarily lost target by a series of operations on the basis of the target information supplied from the process selector 41 and the intermediate data stored in the storage section 44. For example, the lost data holding section 42 determines whether a target should be held on the basis of a holding period (Hold Time) indicating the time passing after the target is lost.

The unreliable data deleting section 43 performs an unreliable data deleting process of deleting an unstable target on the basis of the target information supplied from the process selector 41 and the intermediate data stored in the storage section 44. For example, the unreliable data deleting section 43 determines whether a target is unstable on the basis of the stability in area of the target and a lifetime (Life) indicating the time passing after the target is recognized.

The storage section 44 is supplied with the target information processed by the lost data holding section 42 or the unreliable data deleting section 43, and the storage section 44 stores (holds) the target information as the intermediate data to be used in the internal process of the corrector 27. The intermediate data (for example, the target information previous by one frame) stored in the storage section 44 is referred to in the processes performed by the process selector 41, the lost data holding section 42, and the unreliable data deleting section 43.

The controller 28 executes a higher-level application program of controlling the display (operation) of the display screen of the input and output display 22, for example, depending on the movement of the user's finger or the like coming in contact with the display screen of the input and output display 22. The controller 28 is supplied with the target information corrected by the corrector 27 and the controller 28 controls a display signal processor (not shown) supplying image data to the input and output display 22 as needed on the basis of the supplied target information. Under the control of the controller 28, for example, the display status of the input and output display 22 changes (for example, reduce or enlarge, rotate, and slide).

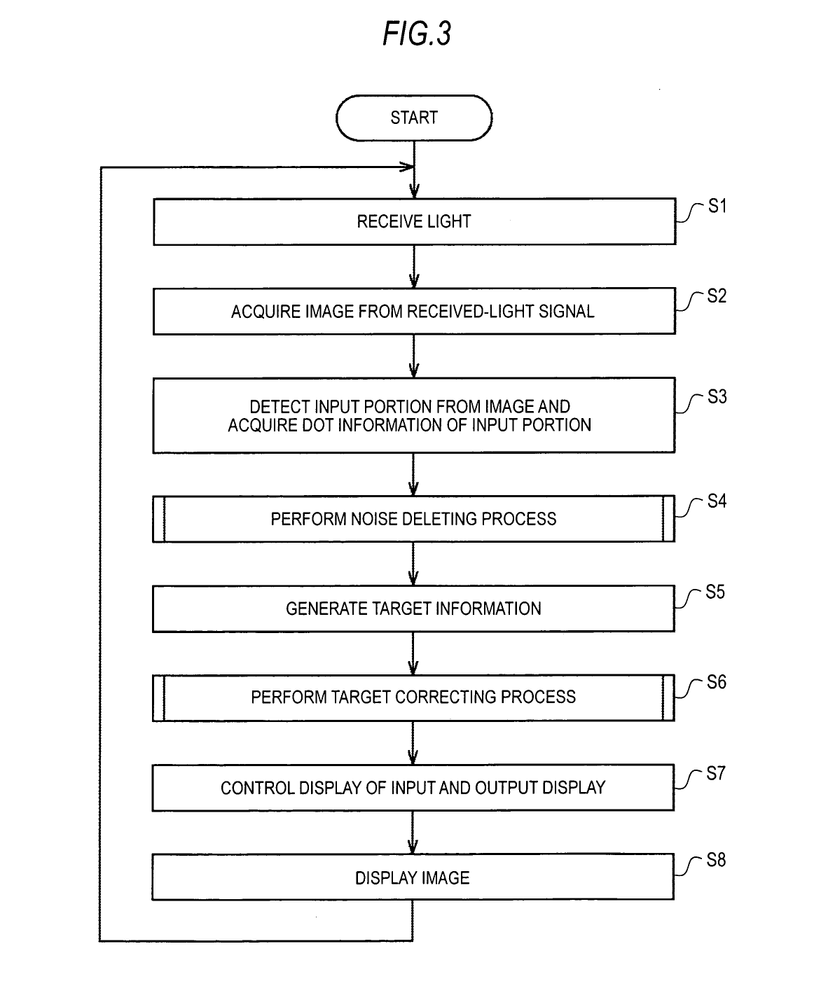

A process of controlling the display depending on the movement of the user's finger or the like on the display screen of the input and output display 22 in the operation input device 21 shown in FIG. 2 will be described below with reference to the flowchart shown in FIG. 3.

For example, when the user turns on the operation input device 21, the flow of processes is started and is repeatedly performed per frame of the image displayed on the input and output display 22.

In step S1, the optical sensors 22A of the input and output display 22 receive the light in synchronization with the display of one frame on the display screen of the input and output display 22 and supplies a received-light signal corresponding to the intensity of the received light to the received-light signal processor 23. The optical sensors 22A receive the reflected light reflected from the user's finger or the like coming in contact with the display screen of the input and output display 22 or the external light applied to the display screen of the input and output display 22.

In step S2, the received-light signal processor 23 performs a predetermined process on the received-light signal supplied from the input and output display 22. Accordingly, the received-light signal processor 23 acquires an image having different brightness between a portion coming in contact with the user's finger and a portion coming in contact with nothing on the display screen of the input and output display 22 and supplies the acquired image to the image processor 24.

In step S3, the image processor 24 performs image processes such as binarization, noise deletion, and labeling on the image supplied from the received-light signal processor 23. The image processor 24 detects a region in which the user's finger or the like comes in contact with the display screen of the input and output display 22 as an input portion having been subjected to an external input by the image processes, acquires dot information of the input portion, and supplies the acquired dot information to the noise deleting section 25.

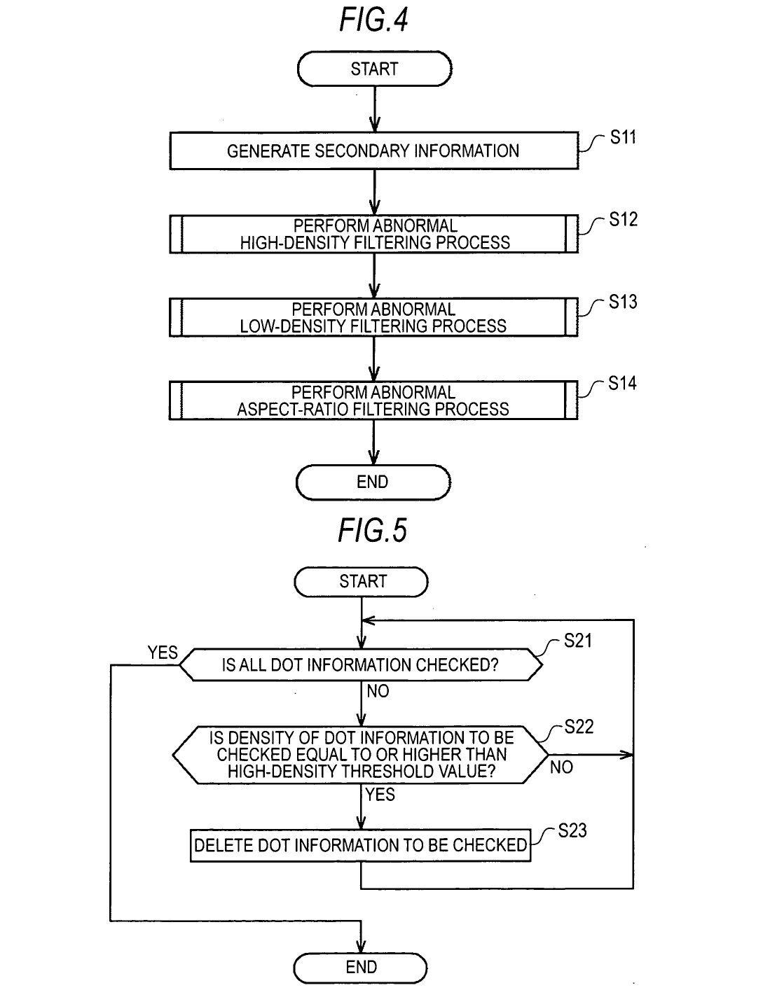

In step S4, the noise deleting section 25 performs a noise deleting process of deleting the dot information of the input portion recognized as a noise component on the basis of the dot information of the input portion supplied from the image processor 24. Details of the noise deleting process will be described later with reference to FIGS. 4 to 7. The noise deleting section 25 supplies the dot information of the input portion not recognized as the noise component to the generator 26.

In step S5, the target generator 31 of the generator synthesizes the dot information of the input portion supplied from the noise deleting section 25 with the target-generation reference data of the entire frames stored in the storage section 32. The target generator 31 generates target information of the input portion recognized as a target by the synthesis process and supplies the generated target information to the corrector 27.

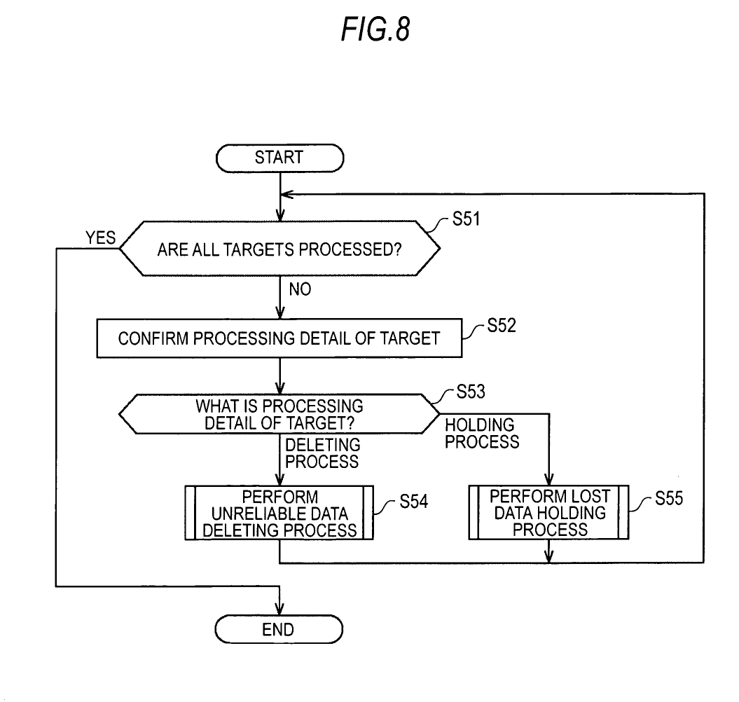

In step S6, the corrector 27 performs a target correcting process of correcting the target information by deleting an unstable target or holding a temporarily lost target on the basis of the target information generated by the generator 26, and supplies the corrected target information to the controller 28. Details of the target correcting process will be described later with reference to FIGS. 8 to 10.

In step S7, the controller 28 controls a display signal processor (not shown) supplying image data to the input and output display 22 to change the display status of the input and output display 22 as needed on the basis of the target information supplied from the corrector 27.

In step S8, the input and output display 22 displays an image in the display status different from the previous one, for example, in the display status in which the displayed image rotates clockwise by 90°, under the display control of the controller 28.

Thereafter, the flow of processes returns to step S1 and the same processes are repeatedly performed on the next frame.

As described above, in the operation input device 21, since the dot information of the input portion recognized as a noise component is deleted and the unstable target is deleted or the temporarily lost target is held, it is possible to make an accurate display control corresponding to the movement of the user's finger or the like. That is, it is possible to prevent an erroneous operation resulting from a sudden variation in light applied to the display screen of the input and output display 22.

FIG. 4 is a flowchart illustrating the noise deleting process in step S4 of FIG. 3.

For example, the process is started when the image processor 24 supplies the dot information of the input portion in a predetermined single frame to the noise deleting section 25. As described above, the dot information of the input portion includes information indicating the coordinates, contact areas, and shapes of all the input portion detected from the frame in process.

In step S11, the noise deleting section 25 generates secondary information of the input portion on the basis of the dot information of the input portions supplied from the image processor 24 so as to extract shape features of the input portions detected from the portions not coming in contact with the object. For example, the noise deleting section 25 generates density values and aspect ratios of the input portions as the secondary information. That is, the noise deleting section 25 acquires a rectangle circumscribing the input portion on the basis of the shape of the input portion and calculates a ratio of the area of the input portion to the area of the circumscribed rectangle as the density value of the input portion. The noise deleting section 25 calculates a length ratio of the horizontal direction to the vertical direction of the circumscribed rectangle as the aspect ratio.

In step S12, the noise deleting section 25 performs an abnormal high-density filtering process (FIG. 5) of deleting the dot information of the input portion of which the density value is equal to or greater than a predetermined high-density threshold value, depending on the density values of the input portions calculated in step S11.

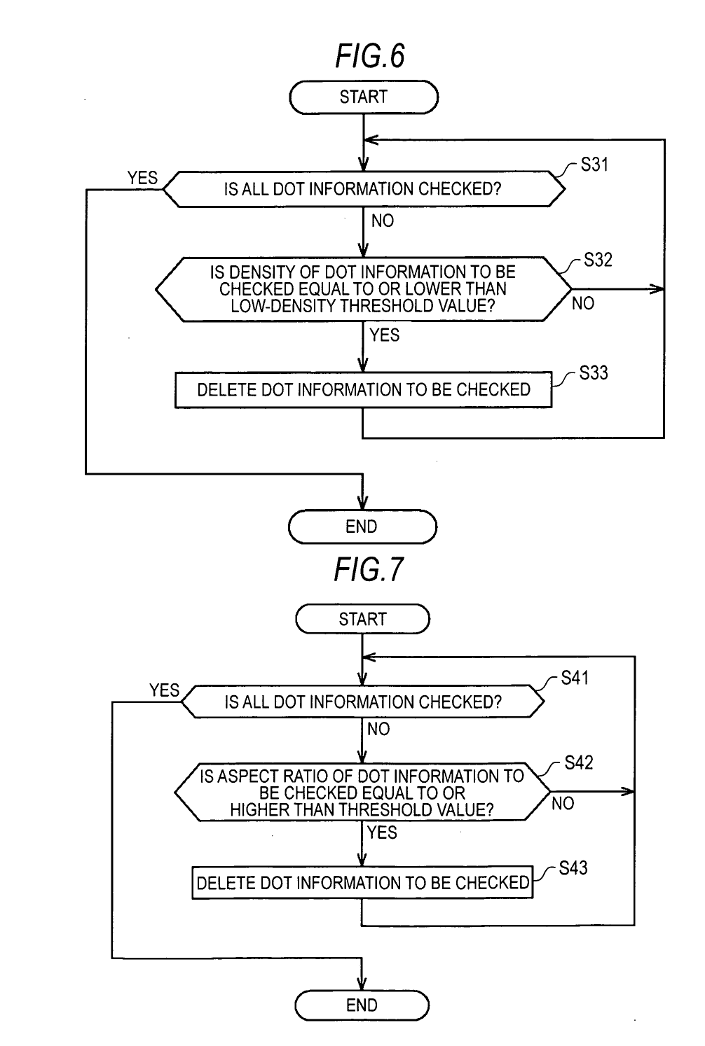

In step S13, the noise deleting section 25 performs an abnormal low-density filtering process (FIG. 6) of deleting the dot information of the input portion of which the density value is equal to or less than a predetermined low-density threshold value, depending on the density values of the input portions calculated in step S11.

In step S14, the noise deleting section 25 performs an abnormal aspect-ratio filtering process (FIG. 7) of deleting the dot information of the input portion of which the aspect ratio is equal to or greater than a predetermined aspect-ratio threshold value, depending on the aspect ratios of the input portions calculated in step S11. The flow of processes is ended after performing the process of step S14.

The abnormal high-density filtering process, the abnormal low-density filtering process, and the abnormal aspect-ratio filtering process will be described with reference to FIGS. 5 to 7. In the noise deleting section 25, a threshold value for responding normally to the input operation of the user's finger or the like is determined, for example, at the time of designing the operation input device 21 and the threshold value is stored in advance.

FIG. 5 is a flowchart illustrating the abnormal high-density filtering process of step S12 in FIG. 4.

In the abnormal high-density filtering process, the noise deleting section 25 sequentially checks the dot information generated from which the secondary information is generated in step S11 of FIG. 4, and determines whether all the dot information from which the secondary information is generated is checked in step S21.

When the noise deleting section 25 determines in step S21 that all the dot information is not checked, that is, when the dot information not checked remains, the process of step S22 is performed.

In step S22, the noise deleting section 25 sets predetermined dot information not having been checked as the target to be checked and determines whether the density value of the dot information to be checked is equal to or greater than the high-density threshold value.

When the noise deleting section 25 determines in step S22 that the dot information to be checked is equal to or greater than the high-density threshold value, the process of step S23 is performed.

In step S23, the noise deleting section 25 deletes the dot information set to be checked in step S22. That is, the dot information of which the density value is equal to or greater than the high-density threshold value, which is abnormally high, is recognized and deleted as a noise component.

After the process of step S23 is performed or when it is determined in step S22 that the density value of the dot information to be checked is not equal to or greater than the high-density threshold value (less than the high-density threshold value), the same processes are repeated from step S21 again.

On the other hand, when the noise deleting section determines in step S21 that all the dot information is checked, all the dot information of which the density value is abnormally high is deleted and the flow of processes is ended.

FIG. 6 is a flowchart illustrating the abnormal low-density filtering process of step S13 in FIG. 4.

In step S31, the noise deleting section 25 determines whether all the dot information from which the secondary information is generated is checked, similarly to step S21 of FIG. 5, and performs the process of step S32 when it is determined that all the dot information is not checked.

In step S32, the noise deleting section 25 sets predetermined dot information not having been checked as information to be checked and determines whether the density value of the dot information to be checked is equal to or less than the low-density threshold value.

When the noise deleting section 25 determines in step S32 that the density value of the dot information to be checked is equal to or less than the low-density threshold value, the noise deleting section 25 deletes the dot information in step S33. That is, the dot information of which the density value is equal to or less than the low-density threshold value, which is abnormally low, is recognized and deleted as the noise component.

After the process of step S33 is performed or when it is determined in step S32 that the density value of the dot information to be checked is not equal to or less than the low-density threshold value (greater than the low-density threshold value), the same processes are repeated from step S31 again.

On the other hand, when the noise deleting section determines in step S31 that all the dot information is checked, all the dot information of which the density value is abnormally low is deleted and the flow of processes is ended.

FIG. 7 is a flowchart illustrating the abnormal aspect-ratio filtering process of step S14 in FIG. 4.

In step S41, the noise deleting section 25 determines whether all the dot information from which the secondary information is generated is checked, similarly to step S21 of FIG. 5, and performs the process of step S42 when it is determined that all the dot information is not checked.

In step S42, the noise deleting section 25 sets predetermined dot information not having been checked as information to be checked, and determines whether the aspect ratio of the dot information to be checked is equal to or greater than the aspect-ratio threshold value.

When the noise deleting section 25 determines in step S42 that the aspect ratio of the dot information to be checked is equal to or greater than the aspect-ratio threshold value, the noise deleting section 25 deletes the dot information in step S43. That is, the dot information of which the aspect ratio is equal to or greater than the aspect-ratio threshold value, which is abnormally low, is recognized and deleted as the noise component.

After the process of step S43 is performed or when it is determined in step S42 that the aspect ratio of the dot information to be checked is not equal to or greater than the aspect-ratio threshold value (less than the aspect-ratio threshold value), the same processes are repeated from step S41 again.

On the other hand, when the noise deleting section determines in step S41 that all the dot information is checked, all the dot information of which the aspect ratio is abnormally high is deleted and the flow of processes is ended.

As described above, the noise deleting section 25 can delete the input portion recognized as the noise component on the basis of the density values and the aspect ratios.

For example, the operation input device 21 is designed to carry out an input operation using a user's finger and a contact region coming in contact with the user's finger is generally elliptical. Accordingly, for example, an input portion from which a shape slimmer than the elliptical shape is detected can be determined as a noise component, not the input operation using the user's finger, and is deleted in the noise deleting process. That is, the high-density threshold value and the low-density threshold value are set to determine a contact region of the user's finger and the aspect-ratio threshold value is set to a highest aspect ratio so as to determine a contact region of the user's finger.

Therefore, it is possible to delete the dot information of the input portion not determined as the operation input using the user's finger by the noise deleting process, for example, to delete the dot information of the non-contact portion detected due to the variation in light applied to the input and output display 22. Accordingly, it is possible to prevent an erroneous operation based on the dot information of the non-contact portion, thereby performing a more accurate operation.

FIG. 8 is a flowchart illustrating the target correcting process of step S6 in FIG. 3. As described above, the processes are repeatedly performed every frame of an image displayed on the input and output display 22 in the operation input device 21 and the frame to be currently processed is properly called a frame at time t.

In step S51, the process selector 41 determines whether all the target information generated by the target generator 31 has been processed. For example, when the user's fingers come in contact with the display screen of the input and output display 22 at plural positions, the target generator 31 recognizes plural targets corresponding to the plural positions in the frame at time t and generates plural pieces of target information. Accordingly, when the plural pieces of target information are generated by the target generator 31, the corrector 27 sequentially processes the pieces of target information.

When it is determined in step S51 that the process selector 41 has not processed all the target information, that is, when the target information not processed remains yet, the process of step S52 is performed.

In step S52, the process selector 41 sets the target information not processed yet as a processing target, confirms the processing details included in the target information, and then performs the process of step S53.

For example, the target information of the input portion recognized as a target by the target generator 31 in the process on the frame at time t−1 (the frame previous by one frame) includes the processing details of the target correcting process at time t−1. Accordingly, the process selector 41 confirms the details with reference to the target information identified by the same target ID as at time t−1 out of the intermediate data stored in the storage section 44.

The process selector 41 writes a deleting process to the processing details of the target information, when the processing details are not included in the target information. That is, the target information of the input portion not recognized as a target in the process on the frame at time t−1 but recognized as a target in the process on the frame at time t does not include the processing details. Accordingly, the process selector 41 writes the deleting process as an initial process of the processing details.

In step S53, the process selector 41 determines whether the processing details (mode) of the target information confirmed (written) in step S52 is a deleting process (delete mode) or a holding process (hold mode).

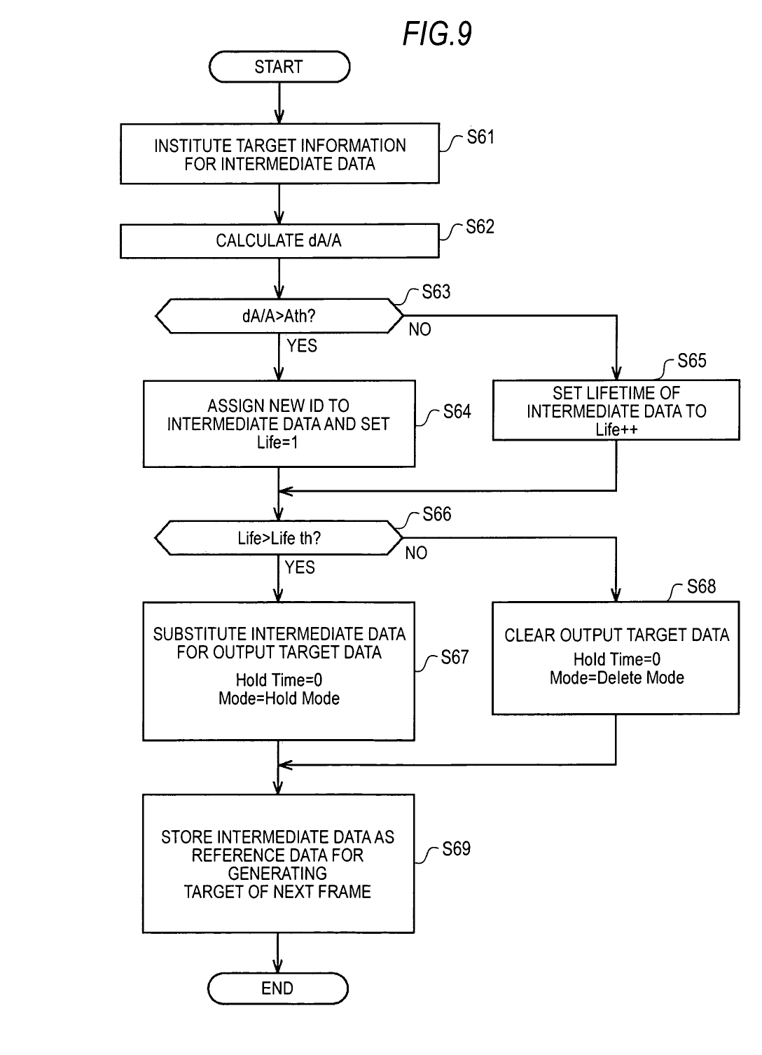

When the process selector 41 determines in step S53 that the processing details of the target information is the deleting process (Mode=Delete Mode), the process selector 41 supplies the target information to the unreliable data deleting section 43 and then the process of step S54 is performed. In step S54, the unreliable data deleting section 43 performs an unreliable data deleting process (FIG. 9) on the target information supplied from the process selector 41 in step S53.

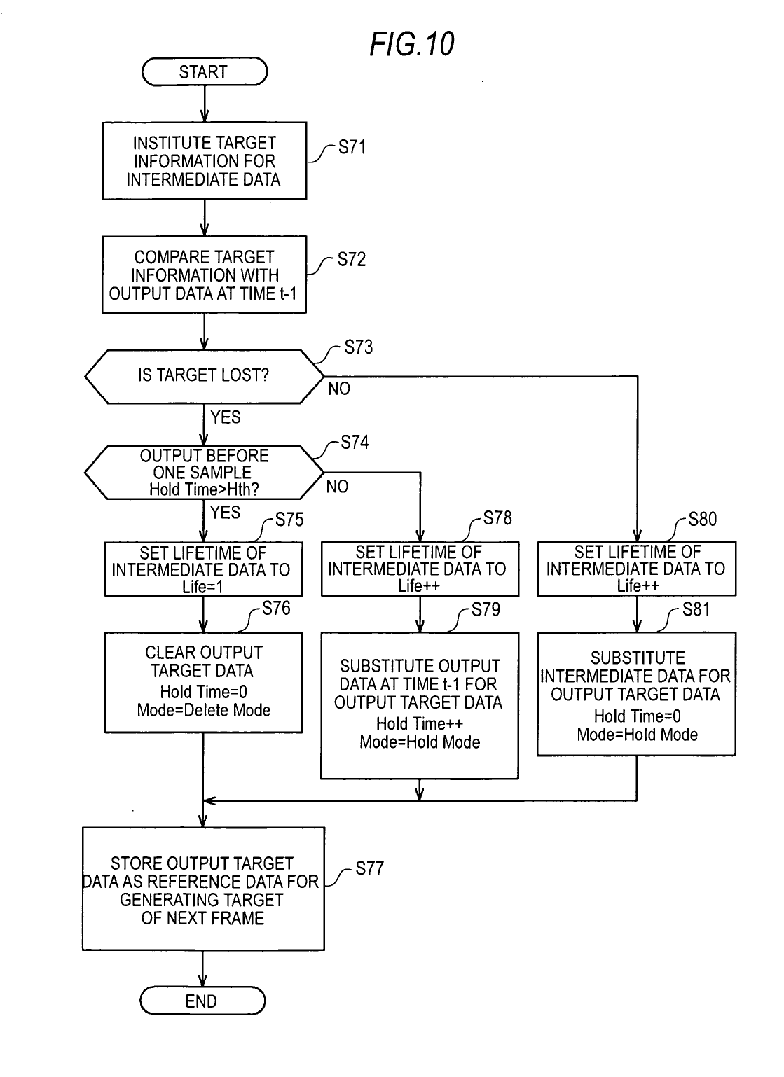

On the other hand, when the process selector 41 determines in step S53 that the processing details of the target information in process is the holding process (Mode=Hold Mode), the process selector 41 supplies the target information to the lost data holding section 42 and then the process of step S55 is performed. In step S55, the lost data holding section 42 performs a lost data holding process (FIG. 10 on the target information supplied from the process selector 41 in step S53.

After the process of step S54 or S55 is processed, the processes are repeatedly performed from step S51 until it is determined in step S51 that all the target information is processed.

Here, the number of repeated times of the target correcting process (that is, the total number of targets) is obtained by adding the number of target information pieces output to the controller 28 in the process on the frame at time t−1 to the number of target information pieces of which the target IDs are not equal to the target IDs included in the target information output to the controller 28 in the process on the frame at time t−1 out of the target information supplied from the generator 26 in the process on the frame at time t.

FIG. 9 is a flowchart illustrating the unreliable data deleting process of step S54 in FIG. 8.

In step S61, the unreliable data deleting section 43 stores the target information generated in the frame at time t by the target generator 31 as the intermediate data at time t in the storage section 44 and performs the process of step S62.

In step S62, the unreliable data deleting section 43 calculates a variation in area (dA/A) using the following Expression (1) on the basis of the area value Aₜ of the intermediate data at time t and an area value Aₜ₋₁ of the intermediate data at time t−1. The intermediate data at time t−1 is the target information having the same target ID as the intermediate data in process out of the target information generated in the frame at time t−1 (previous by one sample) by the target generator 31 and stored in advance as the intermediate data in the storage section 44.

dA/A=|Aₜ₋₁₋Aₜ|/Aₜ₋₁ (1)

After the process of step S62 is performed, the unreliable data deleting section 43 determines in step S63 whether the variation in area calculated in step S62 is greater than an area-variation threshold value (Ath).

When the unreliable data deleting section 43 determines in step S63 that the variation in area is greater than the area-variation threshold value (dA/A>Ath), the process of step S64 is performed. In step S64, the unreliable data deleting section 43 assigns a new ID to the intermediate data in process and sets the lifetime of the new ID assigned to the intermediate data to 1 (Life=1). In this case, since the variation in area is great, the corresponding operation input can be determined as a new operation input, not one of a series of operation inputs, and the target corresponding to the intermediate data in process is considered as being newly generated.

On the other hand, when the unreliable data deleting section 43 determines in step S63 that the variation in area is not greater than the area-variation threshold value (dA/A≦Ath), the process of step S65 is performed. In step S65, the unreliable data deleting section 43 increases the lifetime of the target information in process (Life++). In this case, since the variation in area is small, the corresponding operation input is considered as a stable one of a series of operation inputs.

After the process of step S64 or S65 is performed, the unreliable data deleting section 43 determines in step S66 whether the lifetime of the intermediate data in process is greater than a predetermined lifetime threshold value (Life th).

When the unreliable data deleting section 43 determines in step S66 that the lifetime of the intermediate data is greater than the predetermined lifetime threshold value (Life>Life th), the process of step S67 is performed.

In step S67, the unreliable data deleting section 43 substitutes the intermediate data for the output target data. In this case, since the intermediate data has a small variation in area in the prescribed period, the intermediate data can be determined not to be unreliable data but to be data resulting from the input operation using the user's finger, and the target information of the intermediate data is output to the controller 28. To prevent the loss of the intermediate data having the same ID in the subsequent processes, the processing details of the intermediate data is set to a holding process (Mode=Hold Mode) and the holding period of the intermediate data is set to 0 (Hold Time=0).

On the other hand, when the unreliable data deleting section 43 determines in step S66 that the lifetime of the target information is not greater than the predetermined lifetime threshold value (Life≦Life th), the process of step S68 is performed.

In step S68, the unreliable data deleting section 43 clears the output target data. In this case, the intermediate data can be determined to be unreliable data and thus the target information of the intermediate data is not output to the controller 28. The processing details of the intermediate data is set to the deleting process (Mode=Delete Mode) and the holding period of the intermediate data is set to 0 (Hold Time=0).

After the process of step S67 or S68 is performed, the unreliable data deleting section 43 stores the intermediate data at time t in the storage section 32 of the generator 26 in step S69 and then ends the flow of processes. That is, the intermediate data at time t is considered as target-generation reference data which is referred to by the target generator 31 in the process of generating the target information in the next frame (frame at time t+1).

As described above, the unreliable data deleting section 43 can delete the unreliable data on the basis of the variation in area and the lifetime of the target. Accordingly, it is possible to prevent the erroneous operation.

FIG. 10 is a flowchart illustrating the lost data holding process of step S55 in FIG. 8.

In step S71, the lost data holding section 42 stores the target information generated in the frame at time t by the target generator 31 as the intermediate data at time t in the storage section 44 and performs the process of step S72.

In step S72, the lost data holding section 42 compares the output data at time t−1

(all the target information substituted for the output target data at time t1)

with the intermediate data at time t and then performs the process of step S73.

In step S73, the lost data holding section 42 determines whether the target is lost as the comparison result of the output data at time t−1 with the intermediate data at time t in step S72.

For example, the lost data holding section 42 determines that the target of the corresponding target information is lost, when the target information in which the processing details of the output data at time t−1 is the holding process (Mode=Hold Mode) and which has the target ID (lost target ID) not existing in the intermediate data at time t, at the result of the comparison in step S72.

On the other hand, the lost data holding section 42 determines that the target is not lost, when the target ID included in the target information of the intermediate data at time t is equal to the target ID included in the target information of the output data at time t−1.

When the lost data holding section 42 determines in step S73 that the target is lost, the process of step S74 is performed.

In step S74, the lost data holding section 42 determines whether the holding period (Hold Time) is greater than the predetermined holding-period threshold value (Hth) with reference to the output target data at time t−1 for the target determined to be lost.

When the lost data holding section 42 determines in step S74 that the holding period of the output target data at time t−1 for the target determined to be lost is greater than the predetermined holding-period threshold value (Hold Time>Hth), the process of step S75 is performed.

In step S75, the lost data holding section 42 sets the lifetime of the intermediate data to 1 (Life=1), and then performs the process of step S76.

In step S76, the lost data holding section 42 clears the output target data. In this case, the intermediate data of the target determined to be lost is not output to the controller 28. The lost data holding section 42 sets the processing details of the intermediate data to the deleting process (Mode=Delete Mode) and sets the holding period of the intermediate data to 0 (Hold Time=0).

After the process of step S76 is performed, the lost data holding section 42 stores the output target data at time t as the target-generation reference data in the storage section 32 of the generator 26 in step S77, and then ends the flow of processes. That is, the output target data at time t is considered as the target-generation reference data which is referred to by the target generator 31 in the process of generating the target information in the next frame (frame at time t+1). In this case, in the state where it is considered that the output target data at time t is cleared and the target is lost (for example, the user's finger or the like is separated from the display screen of the input and output display 22), the subsequent processes are performed.

On the other hand, when the lost data holding section 42 determines in step S74 that the holding period of the output target data at time t−1 for the target determined to be lost is not greater than the predetermined holding-period threshold value (Hold Time≦Hth), the process of step S78 is performed.

In step S78, the lost data holding section 42 increases the lifetime of the intermediate data (Life++), and then performs the process of step S79.

In step S79, the lost data holding section 42 copies the output data at time t−1 (that is, the target information determined to be lost out of the target information substituted for the output target data at time t−1) to the output data. In this case, the same target information as the target information previous by one frame is output for the target determined to be lost. The lost data holding section 42 sets the processing details of the intermediate data to the holding process (Mode=Hold Mode) and increases the holding period of the intermediate data (Hold Time++).

After the process of step S79 is performed, the lost data holding section 42 stores the output target data at time t as the target-generation reference data in the storage section 32 in step S77, and ends the flow of processes. In this case, in the state where it is considered that the output target data at time t is copied from the output data at time t−1 and the lost target is held, the subsequent processes are performed.

On the other hand, when the lost data holding section 42 determines in step S73 that the target is not lost, the process of step S80 is performed.

In step S80, the lost data holding section 42 increases the lifetime of the intermediate data at time t (Life++) and performs the process of step S81.

In step S81, the lost data holding section 42 substitutes the intermediate data for the output target data. In this case, since the target is not lost, the intermediate data is output to the controller 28. The lost data holding section 42 sets the processing details of the intermediate data to the holding process (Mode=Hold Mode) and sets the holding period of the intermediate data to 0 (Hold Time=0).

After the process of step S81, the lost data holding section 42 stores the output target data at time t as the target-generation reference data in the storage section 32 in step S77, and then ends the flow of processes. In this case, since the target is not lost, the subsequent processes are performed using the detected target.

As described above, the lost data holding section 42 can determine that the target is temporarily lost by setting the holding period to be equal to or less than a predetermined threshold value when the target is lost. Accordingly, the lost data holding section performs the process of holding the output data previous by one frame as the target. Accordingly, by determining that the target is temporarily lost, for example, it is possible to prevent the erroneous operation due to the determination that the operations before and after the loss are different from each other. That is, processing can be performed with the operations being a series of input if the loss is temporary.

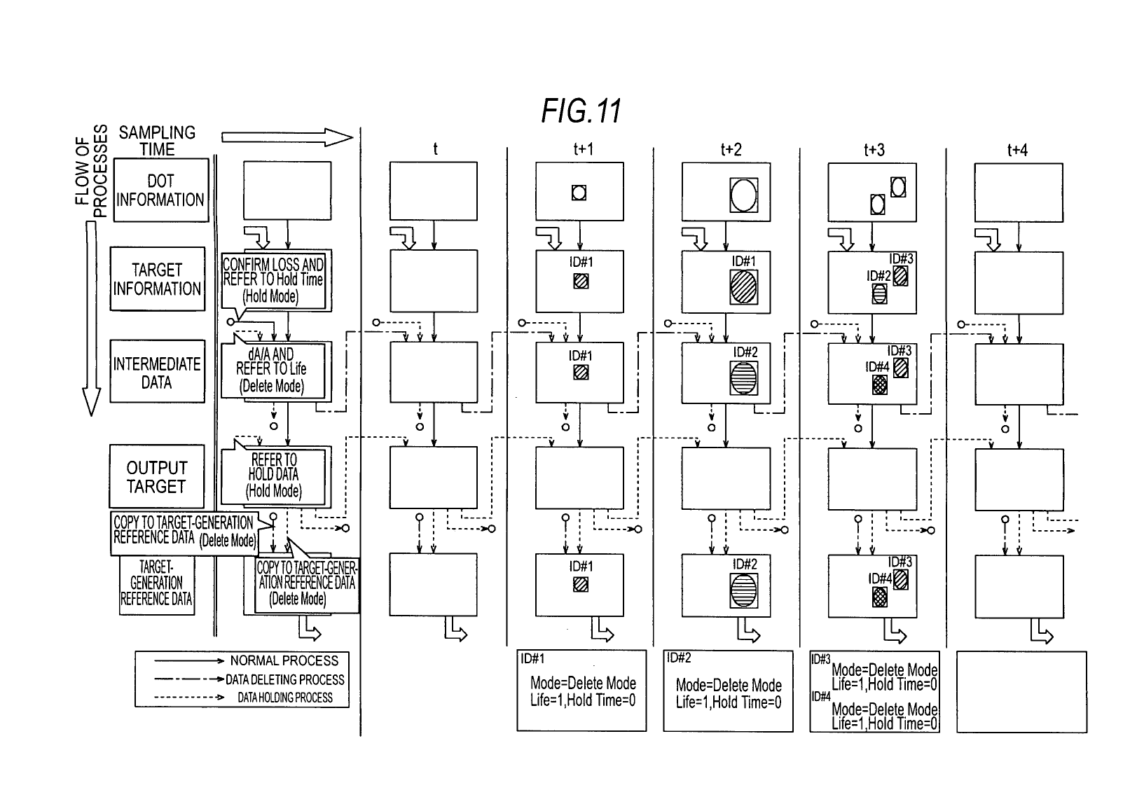

The operation of the corrector 27 will be described below with reference to FIGS. 11 to 13. In this operation, the lifetime threshold value (Life th) is set to 1 and the holding-period threshold value (Hth) is set to 1.

In FIGS. 11 to 13, the sampling time is shown in the horizontal direction and time t passes from the left to the right. In FIGS. 11 to 13, the flow of processes is shown in the vertical direction. That is, from the upside to the downside, the dot information of the input portion input to the target generator 31, the target information generated by the target generator 31, the intermediate data stored in the storage section 44, the output target data output to the controller 28, and the target-generation reference data stored in the storage section 32.

FIG. 11 shows the effect of the unreliable data deleting process in the unreliable data deleting section 43 of the corrector 27.

For example, the target generator 31 newly detects a target at time t+1, assigns target ID #1 to the target, sets the lifetime to 1 (Life=1), and sets the holding period to 0 (Hold Time=0). The process selector 41 writes the deleting process as the initial process of the processing details (the process of step S52 in FIG. 8).

When a successive target is detected at time t+2, the target generator 31 assigns the target ID #1 of the target detected at time t+1 to the target. However, the target detected at time t+2 suddenly varies to the area much greater than the area of the target with the target ID #1 detected at time t+1. For example, when the variation in area is greater than the area variation threshold value (dA/A>Ath), the unreliable data deleting section 43 assigns a new ID (a target ID #2) to the target detected at time t+2 (the process of step S64 in FIG. 9). Since the lifetime is equal to or less than 1 (Life≦Life th), the output target data is cleared and the target information with the target ID #2 is not output (the process of step S68 in FIG. 9).

Thereafter, two targets are detected at time t+3, and the target generator 31 assigns the target ID #2 to one thereof. However, the area of the target with the target ID #2 at time t+3 varies to the area much smaller than the area of the target with the target ID #2 at time t+2. Accordingly, the unreliable data deleting section 43 assigns a new ID (target ID #4) to the target and clears the output target data.

In this way, since the unreliable data deleting section 43 performs the unreliable data deleting so as not to output the target having a great variation in area which is an unstable target, it is possible to prevent the erroneous operation due to the unstable target other than the user's input operation.

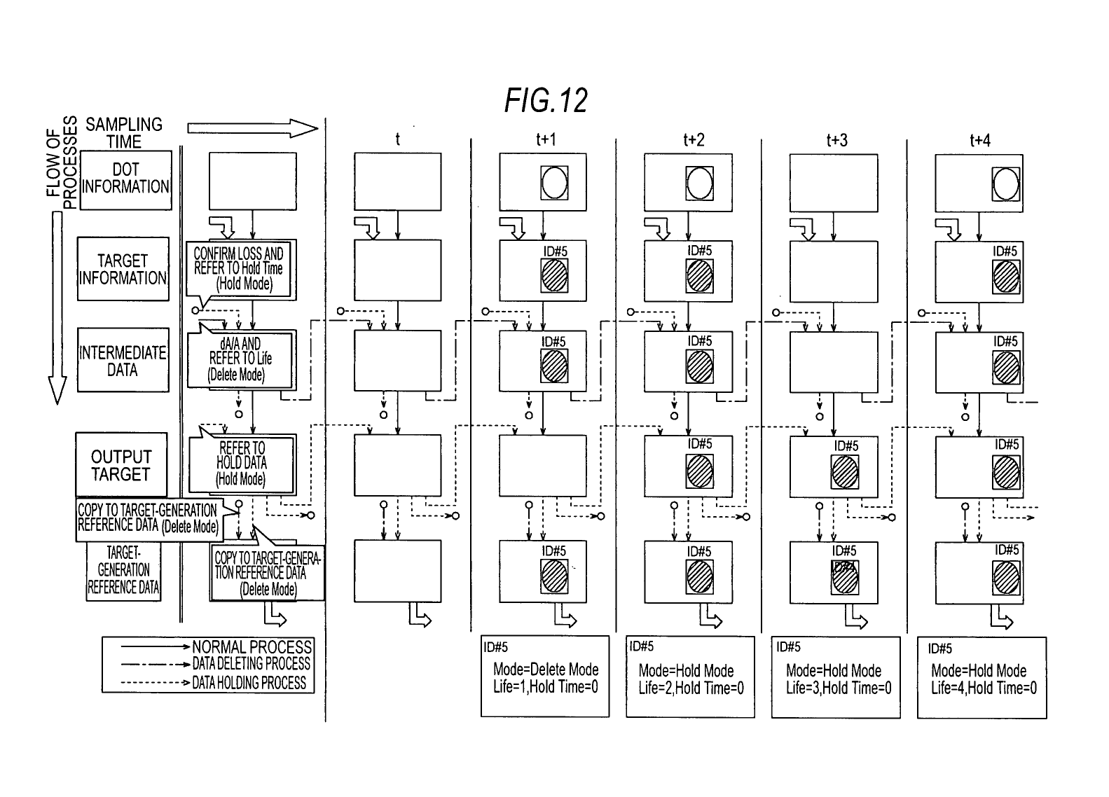

FIG. 12 shows the effect of the lost data holding process in the lost data holding section 42 of the corrector 27.

For example, the target generator 31 newly detects a target at time t+1, assigns a target ID #5 to the target, sets the lifetime to 1 (Life=1), and sets the holding period to 0 (Hold Time=0). The process selector 41 writes the deleting process as the initial process of the processing details (Mode=Delete Mode) (the process of step S52 in FIG. 8).

When a successive target is detected at time t+2, the target generator 31 assigns the target ID #5 of the target, which is detected at time t+1, to the target. Since the processing details is the deleting process (Mode=Delete Mode), the target information is supplied to the unreliable data deleting section 43. However, since the area of the target detected at time t+2 is equal to the area of the target with the target ID #5 detected at time t+1, the lifetime of the intermediate data thereof is increased (the process of step S65 in FIG. 9).

Since the lifetime is greater than 1 (Life>Life th), the unreliable data deleting section 43 substitutes the intermediate data for the output target data, sets the processing details to the holding process (Mode=Hold Mode), and sets the holding period to 0 (Hold Time=0). Accordingly, the target information of the target ID #5 is output.

It is assumed that no target is detected at time t+3. Then, since the processing details of the intermediate data of the target ID #5 is the holding process, the lost data holding process is performed by the lost data holding section 42 and the same target information as the target information previous by one frame is output (the process of step S79 in FIG. 10).

In this way, when a stable target is temporarily lost, it is possible to assign the same ID to a series of operation inputs without assigning different target IDs to the operation inputs before and after the loss, by holding the target. Accordingly, it is possible to prevent the erroneous operation due to the determination that two different operations are input.

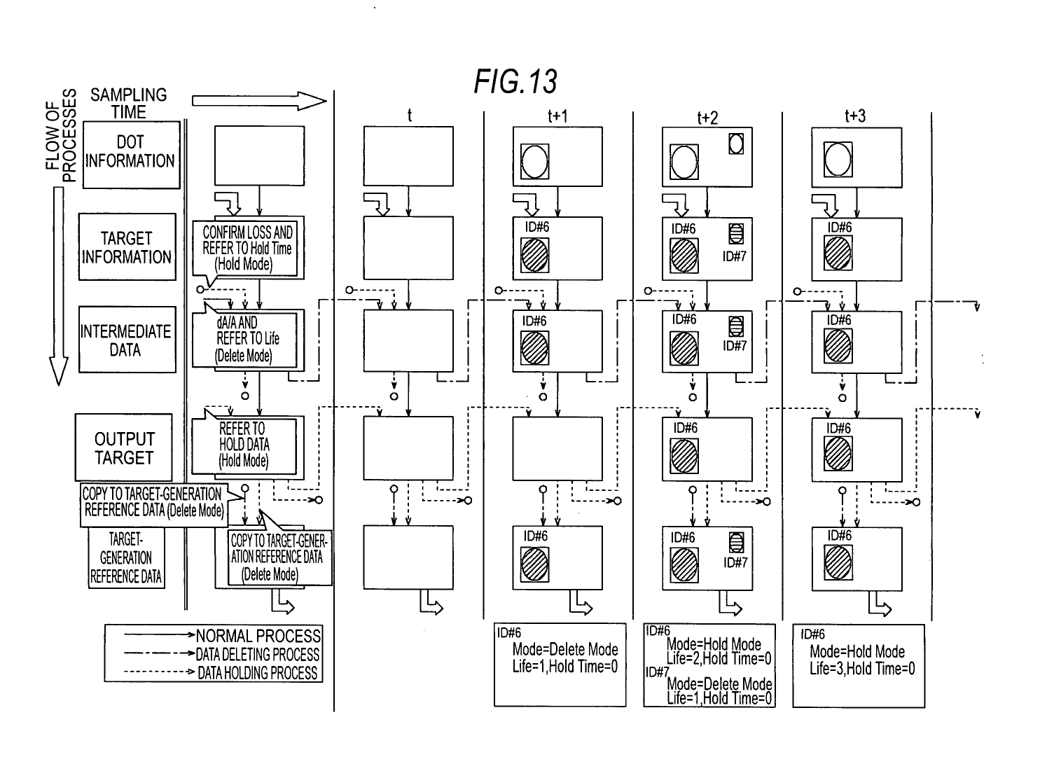

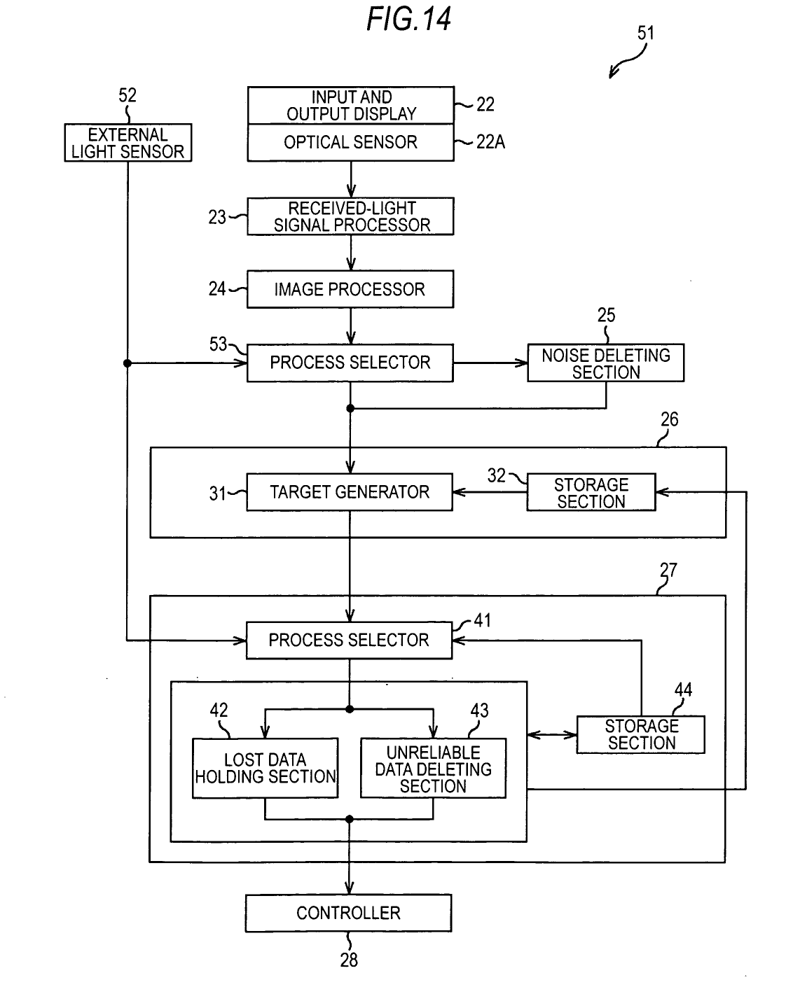

FIG. 13 shows the effect of the unreliable data deleting process in the unreliable data deleting section 43 of the corrector 27. FIG. 14 shows an operation when an unstable target is generated along with the target based on the input operation of the user's finger.

That is, from time t+1 to time t+3, the target with the target ID #6 is detected as a stable input portion, but the target with the target ID #7 detected at time t+2 is an unstable target temporarily generated and is thus deleted.

In this way, the unreliable data deleting process and the lost data holding process are independently distributed every target using the target IDs for identifying the targets. Accordingly, even when an unstable target is generated during the user's input operation, it is possible to delete only the unstable target without affecting the target based on the operation input.

In this way, by selectively performing the unreliable data deleting process and the lost data holding process, plural pieces of dot information having been input from the outside can be easily treated in a higher-level application program executed by the operation input device 21 having the input and output display 22. By removing the noise component resulting from the temporal or spatial variation of light applied to the input and output display 22, it is possible to prevent a target from being lost in operation with a non-complete reflector such as a finger, thereby preventing the erroneous operation in the higher-level application program.

FIG. 14 is a block diagram illustrating the configuration of an operation input device according to a second embodiment of the invention.

In FIG. 14, the operation input device 51 includes an external light sensor 52, a selection processor 53, an input and output display 22, a received-light signal processor 23, an image processor 24, a noise deleting section 25, a generator 26, a corrector 27, and a controller 28. In FIG. 14, the same elements as the operation input device 21 shown in FIG. 2 are referenced by like reference numerals and signs, and description thereof is not repeated.

That is, the operation input device 51 of FIG. 14 is similar to the operation input device 21 of FIG. 2, in that it includes the input and output display 22, the received-light signal processor 23, the image processor 24, the noise deleting section 25, the generator 26, the corrector 27, and the controller 28. However, the operation input device 51 of FIG. 14 is different from the operation input device 21 of FIG. 2, in that it further includes the external light sensor 52 and the selection processor 53.

The external light sensor 52 detects statuses of external light (such as luminance of the external light, a spectrum of the external light, and an application direction of the external light) applied to the input and output display 22, acquires external light information indicating the external light statuses, and supplies the external light information to the process selectors 41 and 53.

The selection processor 53 selects whether the noise deleting section 25 should be made to perform the noise deleting process on the basis of the external light information supplied from the external light sensor 52. For example, the selection processor 53 supplies the dot information of the input portion to the noise deleting section 25 to perform the noise deleting process, when the external light applied to the input and output display 22 generates a noise component in the dot information of the input portion detected by the image processor 24. On the other hand, the selection processor 53 supplies the dot information of the input portion to the generator 26 when the external light applied to the input and output display 22 does not generate a noise component in the dot information of the input portion detected by the image processor 24. In this case, the noise deleting process is not performed by the noise deleting section 25.

In this way, by causing the selection processor 53 to select whether the noise deleting section 25 should be made to perform the noise deleting process, it is possible to skip the noise deleting process and thus to enhance the processing speed when the external light status does not generate the noise component.

In the operation input device 51, the external light information is supplied to the process selector 41 of the corrector 27 from the external light sensor 52 and a target correcting process based on the external light information is performed by the corrector 27.

For example, an external light condition that a target is not lost but an unstable target is generated and an external light condition that an unstable target is not generated but a target is lost can exist depending on the statuses of the external light applied to the input and output display 22. An external light condition that an unstable target is generated and a target is lost and an external light condition that an unstable target is not generated and a target is not lost also exist. Accordingly, the process selector 41 determines a process to be performed in the target correcting process depending on the statuses of the external light applied to the input and output display 22 on the basis of the external light information supplied from the external light sensor 52.

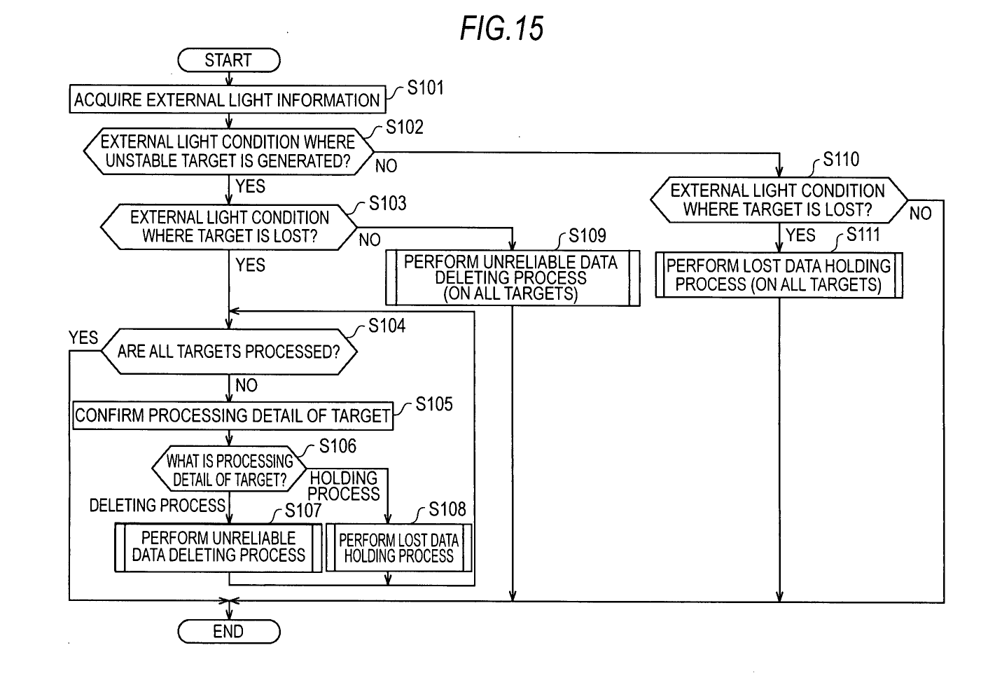

That is, FIG. 15 is a flowchart illustrating the target correcting process performed in the operation input device 51 shown in FIG. 14.

In step S101, the external light sensor 52 detects the statuses of the external light applied to the input and output display 22, acquires the external light information, and supplies the external light information to the process selector 41 of the corrector 27.

In step S102, the process selector 41 determines whether a present external light condition is the external light condition that an unstable target is generated, on the basis of the external light information supplied from the external light sensor 52 in step S101.

When the process selector 41 determines in step S102 that the present external light condition is the external light condition that an unstable target is generated, the process selector 41 determines in step S103 whether the present external light condition is the external light condition that a target is lost.

When the process selector 41 determines in step S103 that the present external light condition is the external light condition that a target is lost, the process of step S104 is performed. In this case, since the present external light condition is the external light condition that an unstable target is generated and a target is lost, one of the unreliable data deleting process and the lost data holding process is selectively performed.

In steps S104 to S108, one of the unreliable data deleting process and the lost data holding process is performed on all the targets and then the flow of process is ended, similarly to steps S51 to S55 in FIG. 8.

On the other hand, when the process selector 41 determines in step S103 that the present external light condition is not the external light condition that a target is lost, the process of step S109 is performed. In this case, the statuses of the external light applied to the input and output display 22 satisfy the external light condition that a target is not lost and an unstable target is generated.

In step S109, the process selector 41 supplies all the target information to the unreliable data deleting section 43, the unreliable data deleting section 43 performs the unreliable data deleting process on all the targets, and then the flow of processes is ended.

On the other hand, when the process selector 41 determines in step S102 that the present external light condition is not the external light condition that an unstable target is generated, the process selector 41 determines whether the present external light condition is the external light condition that a target is lost in step S110.

When the process selector 41 determines in step S110 that the present external light condition is the external light condition that a target is lost, the process of step S111 is performed. In this case, the status of the external light applied to the input and output display 22 satisfies the external light condition that an unstable target is not generated but a target is lost.

In step S111, the process selector 41 supplies all the target information to the lost data holding section 42, the lost data holding section 42 performs the lost data holding process on all the targets, and then the flow of processes is ended.

On the other hand, when process selector 41 determines in step S110 that the present external light condition is not the external light condition that a target is lost, the unreliable data deleting process and the lost data holding process are not performed and the flow of processes is ended. In this case, the status of the external light applied to the input and output display 22 satisfies the external light condition that an unstable target is not generated and a target is not lost.

As described above, since the process to be performed is selected depending on the external light condition, it is possible to perform an optimal process depending on the luminance in an environment where the operation input device 51 is used. For example, in the external light condition that a target is lost or the external light condition that an unstable target is generated, the process to be performed is selected so as to improve the processing performance (for example, to perform an accurate operation instead of any erroneous operation). In the external light condition that a target is not lost and an unstable target is not generated, the process to be performed is selected so as to improve the processing speed. Accordingly, it is possible to more effectively prevent the erroneous operation.

The lost data holding section 42 or the unreliable data deleting section 43 can optimize the threshold values used in the processes depending on the external light conditions.

For example, in the external light condition that a target can be easily lost, the lost data holding section 42 can set the holding-period threshold value (Hth) to a greater value so that a target should hardly be lost. In the external light condition that an unstable target can be easily generated, the unreliable data deleting section 43 can set the lifetime threshold value (Life th) to a greater value so that an unstable target can be easily deleted.

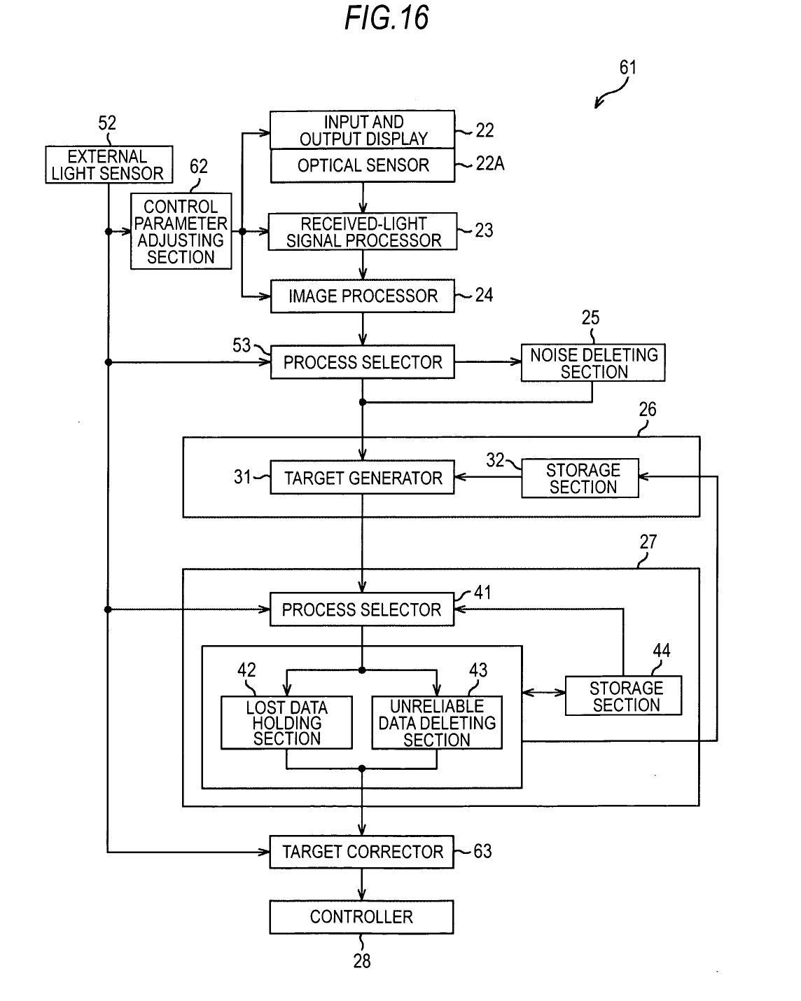

FIG. 16 is a block diagram illustrating the configuration of an operation input device according to a third embodiment of the invention.

In FIG. 16, the operation input device 61 includes a control parameter adjusting section 62, a target corrector 63, an external light sensor 52, a selection processor 53, an input and output display 22, a received-light signal processor 23, an image processor 24, a noise deleting section 25, a generator 26, a corrector 27, and a controller 28. In FIG. 16, the same elements as those of the operation input device 51 shown in FIG. 14 are referenced by like reference numerals and signs, and description thereof is not repeated.

That is, the operation input device 61 of FIG. 16 is similar to the operation input device 51 of FIG. 14, in that it includes the external light sensor 52, the selection processor 53, the input and output display 22, the received-light signal processor 23, the image processor 24, the noise deleting section 25, the generator 26, the corrector 27, and the controller 28. However, the operation input device 61 of FIG. 16 is different from the operation input device 51 of FIG. 14, in that it further includes the control parameter adjusting section 62 and a target corrector 63.

The control parameter adjusting section 62 is supplied with the external light information indicating the status of the external light applied to the input and output display 22 from the external light sensor 52. The control parameter adjusting section 62 adjusts the emission intensity (Power) of light-emitting elements in the display screen of the input and output display 22 or a signal level lower limit (Signal Th) in the received-light signal processor 23. The control parameter adjusting section 62 adjusts an area upper limit (Amax) and an area lower limit (Amin) in the image processor 24 on the basis of the luminance of the external light.

The target corrector 63 is supplied with the corrected target information from the lost data holding section 42 or the unreliable data deleting section 43 of the corrector 27 and is supplied with the external light information from the external light sensor 52. The target corrector 63 amplifies the area value of the target included in the target information with a gain calculated on the basis of the external light information from the external light sensor 52 and supplies the resultant target information to the controller 28.

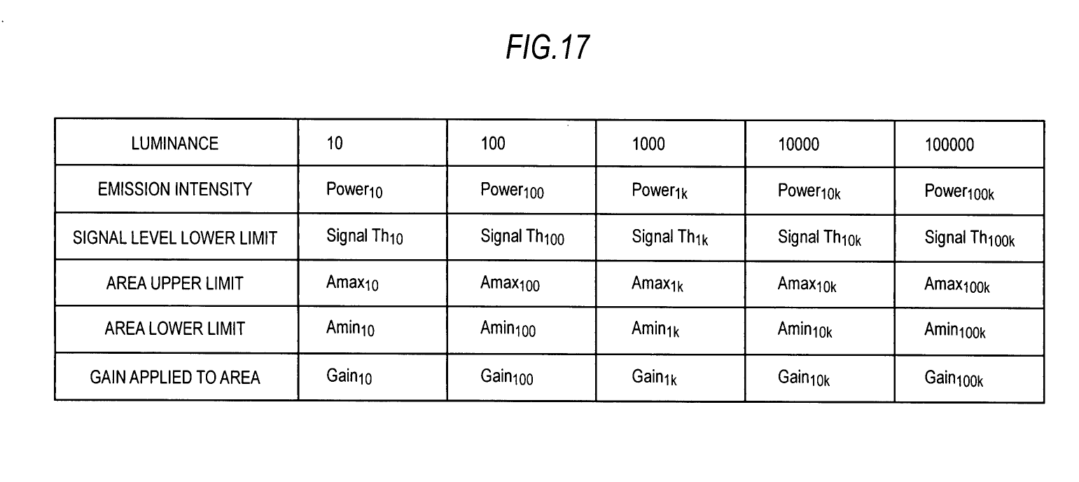

For example, the control parameter adjusting section and the target corrector 63 can store a table (necessary parts thereof) in which predetermined setting values of the parameters are registered every representative luminance as shown in FIG. 17. The control parameter adjusting section 62 and the target corrector 63 can determine the parameters with reference to the table shown in FIG. 17, depending on the luminance included in the external light information supplied from the external light sensor 52.

In the table of FIG. 17, 10, 100, 1000, 10000, and 100000 are registered as the representative luminance and the emission intensity Power₁₀, the signal level lower limit Signal Th₁₀, the area upper limit Amax₁₀, the area lower limit Amin₁₀, and the gain Gain₁₀ are registered to be correlated with the representative luminance 10. Similarly, the emission intensities Power₁₀₀ to Power₁₀₀₀₀₀ the signal level lower limit Signal Th₁₀₀ to Signal Th₁₀₀₀₀₀, the area upper limits Amax₁₀₀ to Amax₁₀₀₀₀₀, the area lower limits Amin₁₀₀ to Amin₁₀₀₀₀₀, and the gains Gain₁₀₀ to Gain₁₀₀₀₀₀ are registered to be correlated with the representative luminance values 100 to 100000.

Here, an example where the control parameter adjusting section 62 calculates the emission intensity Power_{L} where the luminance value of the external light information from the external light sensor 52 is L will be described. For example, the representative luminance value which is the greatest and equal to or lower than the luminance value L is Lₐ and the representative luminance value which is the smallest and equal to or greater than the luminance value L is L_{b}. Here, the control parameter adjusting section 62 sets the emission intensity correlated with the representative luminance value Lₐ to Powerₐ and sets the emission intensity correlated with the representative luminance value L_{b} to Power_{b}, with reference to the table shown in FIG. 17.

The control parameter adjusting section 62 calculates the emission intensity PowerL by calculating the following Expression (2).

$${Power}_{L} = ( {Power}_{b} - {Power}_{a} ) \times \frac{log L - log {L}_{a}}{log {L}_{b} - log {L}_{a}} + {Power}_{a} \qquad ( 2 )$$

The parameters other than the emission intensity PowerL, that is, the signal level lower limit Signal ThL, the area upper limit AmaxL, the area lower limit AminL, and the gain GainL, can be calculated using Expression (2), similarly to the emission intensity PowerL.

When the number of representative luminance values registered in the table is sufficiently great, the parameters can be calculated using the following Expression (3) which is obtained by simplifying Expression (2).

$${Power}_{L} = ( {Power}_{b} - {Power}_{a} ) \times \frac{L - {L}_{a}}{{L}_{b} - {L}_{a}} + {Power}_{a} . \qquad ( 3 )$$

As described above, in the operation input device 61 shown in FIG. 16, since the parameters are adjusted on the basis of the output of the external light sensor 52, it is possible to prevent the decrease in detection rate, for example, under a high-luminance environment.

That is, in the past input and output panel, the signal intensity of the optical sensor resulting from a non-complete reflector such as a finger is affected by the transmitted light under the high-luminance environment such as outdoors, and the number of optical sensors recognizing an input is smaller than that under a low-luminance environment such as indoors. For example, in case of a non-complete reflector such as a finger of which sectional shape is elliptical, the signal intensity of the optical sensors around the boundary of the contact region and the non-contact region suddenly varies under the low-luminance environment, but the signal intensity of the optical sensors around the boundary of the contact region and the non-contact region slowly varies under the high-luminance environment. Accordingly, when the input recognition is carried out using constant threshold values in the received-light signal process and the image process, the number of optical sensors recognizing the input light varies depending on the luminance and the area of the dot information becomes smaller with higher luminance.

When the process of deleting the dot information having an area smaller than a predetermined value is performed to delete the noise, the dot information may be deleted. As a result, in the input operation using the non-complete reflector such as a finger under the high-luminance environment such as outdoors, the number of optical sensors recognizing an input may be smaller than that under the low-luminance environment, the detection rate may be decreased due to the noise deleting process using the area value, and thus the operability may be decreased.

On the contrary, in the operation input device 61, for example, by amplifying the area value at the time of outputting the target with a gain corresponding to the external light condition, it is possible to generate a target having the same area value for the same input target without being affected by the surrounding environment light. Accordingly, since the area of a target can be kept constant under the high-luminance environment and the low-luminance environment, it is possible to prevent the decrease in detection rate and thus to maintain the operability. That is, it is possible to prevent the decrease in detection rate due to the external light condition.

In the operation input device 61, since the variation in behavior due to the above-mentioned external light condition is prevented in the process using the area of a target in a higher-level application program, for example, in the process using an increase in contact area due to a user's strong press with a finger, it is possible to accurately perform the process.

In the operation input device 51 shown in FIG. 14, some of the plural optical sensors 22A arranged in the input and output display 22 may be used as the external light sensor 52, instead of providing an exclusive sensor for detecting the external light status. In this way, when some of the optical sensors 22A are used as the sensor for detecting the external light status, it is possible to make a control using the external light status without adding a new device to a system of the operation input device 51. The same is true in the operation input device 61 shown in FIG. 16.

The above-mentioned series of processes may be embodied by hardware or software. When the series of processes are embodied by software, a program of the software is installed in a computer mounted on exclusive hardware or a general-purpose personal computer, which can perform various functions by installing various programs therein, from a program recording medium.

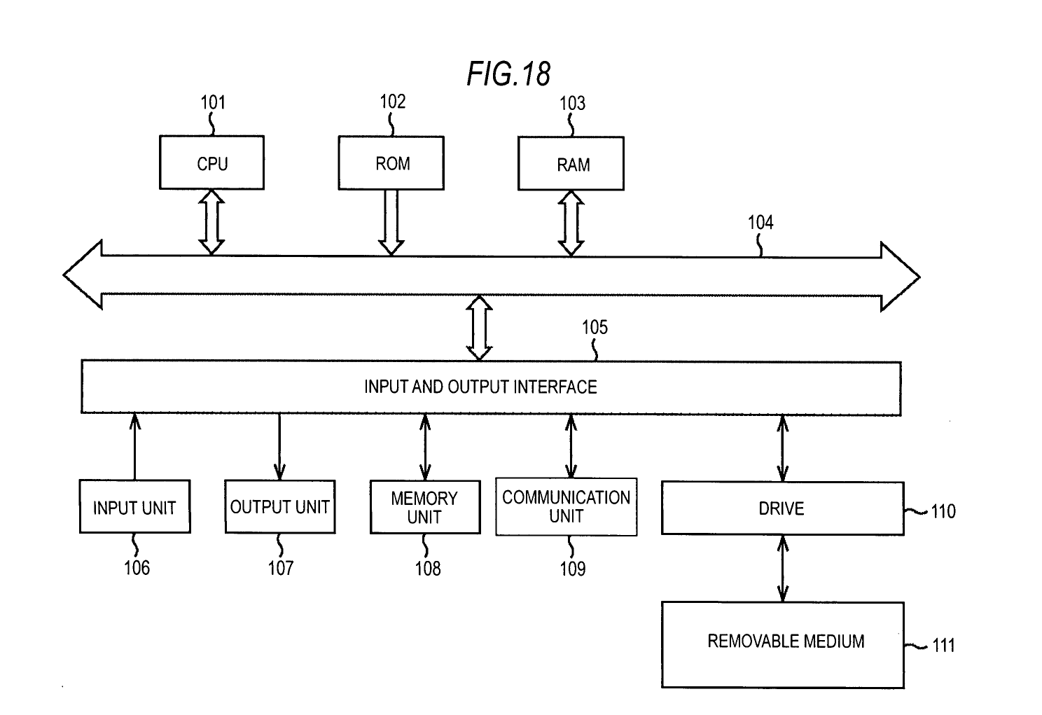

FIG. 18 is a block diagram illustrating a hardware configuration of a computer performing the above-mentioned series of processes by the use of a program.

In a computer, a CPU (Central Processing Unit) 101, a ROM (Read Only Memory) 102, and a RAM (Random Access Memory) 103 are connected to each other via a bus 104.

In addition, an input and output interface 105 is connected to the bus 104. The input and output interface 105 is also connected to an input unit 106 including a keyboard, a mouse, and a microphone, an output unit 107 including a display and a speaker, a memory unit 108 including a hard disk or a nonvolatile memory, a communication unit 109 including a network interface, and a drive 110 driving a removable medium 111 such as a magnetic disk, an optical disk, a magneto-optical disk, or a semiconductor memory.

In the computer having the above-mentioned configuration, the above-mentioned series of processes are performed by causing the CPU 101 to load, for example, a program stored in the memory unit 108 to the RAM 103 via the input and output interface 105 and the bus 104 and to execute the program.

The programs executed by the computer (the CPU 101) are recorded on a removable medium 111 which is a package medium such as a magnetic disk (flexible disk), an optical disk (CD-ROM (Compact Disc-Read Only Memory)), a DVD (Digital Versatile Disk), a magneto-optical disk, and a semiconductor memory or are provided via wired or wireless mediums such as a LAN, the Internet, and a digital broadcast.

The programs can be installed in the memory unit 108 via the input and output interface 105 by mounting the removable medium 111 on the drive 110. The programs may be received by the communication unit 109 via the wired or wireless mediums and may be installed in the memory unit 108. In addition, the programs may be installed in the ROM 102 or the memory unit 108 in advance.

The programs executed by the computer may not be necessarily performed in time series in accordance with the sequences described in the flowcharts and may include processes (such as parallel processes or processes using objects) performed in parallel or individually. The programs may be executed by a CPU or may be distributed and executed by plural CPUs.

The invention is not limited to the above-mentioned embodiments, but may be modified in various forms without departing from the spirit and scope of the invention.

What is claimed is:

1. An operation input device comprising:
input and output means for detecting light corresponding to a plurality of operation inputs to a display screen displaying an image from an outside;
target generating means for generating information of a target indicating a series of inputs on the basis of a temporal or spatial positional relation of input portions having been subjected to the input from the outside;
lost data holding means for holding a lost target when the target generated by the target generating means is temporarily lost;
unreliable data deleting means for deleting an unstable target when the unstable target is generated by the target generating means; and
process selecting means for selecting one of a process performed by the lost data holding means and a process performed by the unreliable data deleting means.

2. The operation input device according to claim 1, further comprising noise deleting means for extracting shape features of the input portions based on the light detected by the input and output means, deleting the input portion having an abnormal shape feature, and supplying the target generating means with the input portions not having the abnormal shape feature.

3. The operation input device according to claim 1, wherein the processes are repeatedly performed on the image displayed on the display screen of the input and output means frame by frame,
wherein the operation input device further comprises memory means for storing information of the target generated by the target generating means as intermediate data which is referred to in the process on the next frame, and
wherein the process selecting means selects the process to be performed on the target in process on the basis of the intermediate data stored in the memory means.

4. The operation input device according to claim 3, wherein the process selecting means selects the process performed on the target in process by the unreliable data deleting means when the information corresponding to the target in process does not exist in the intermediate data stored in the memory means.

5. The operation input device according to claim 1, wherein a lifetime indicating a period of time after the information of the target corresponding to the intermediate data is generated by the target generating means is set in the intermediate data, and
wherein the process selecting means sets the process on the target in the next frame to the process performed by the lost data holding means when the length of the lifetime is equal to or greater than a predetermined threshold value.

6. The operation input device according to claim 1, wherein a holding period indicating a period of time until the holding process is performed by the lost data holding means after the target corresponding to the intermediate data is lost is set in the intermediate data, and
wherein the process selecting means sets the process on the target in the next frame to the process performed by the unreliable data deleting means when the length of the holding period is equal to or greater than a predetermined threshold value.

7. The operation input device according to claim 1, wherein a lifetime indicating a period of time after the information of the target corresponding to the intermediate data is generated by the target generating means and a holding period indicating a period of time until the holding process is performed by the lost data holding means after the target corresponding to the intermediate data is lost are set in the intermediate data, and
wherein the process selecting means selects one of the process performed by the lost data holding means and the process performed by the unreliable data deleting means as the process on the target in process in the next frame on the basis of the length of the lifetime and the length of the holding period.

8. The operation input device according to claim 1, wherein the unreliable data deleting means sets the target in process as a new target when a variation in area based on the intermediate data previous by one frame is equal to or greater than a predetermined threshold value.

9. The operation input device according to claim 1, further comprising external light detecting means for detecting a status of external light applied to the display screen of the input and output means,
wherein the process selecting means selects one of the process performed by the lost data holding means and the process performed by the unreliable data deleting means on the basis of the status of the external light detected by the external light detecting means.

10. An operation input method comprising the steps of:
detecting light corresponding to a plurality of operation inputs to a display screen displaying an image from an outside;
generating information of a target indicating a series of inputs on the basis of a temporal or spatial positional relation of input portions having been subjected to the input from the outside;
holding a lost target when the generated target is temporarily lost;
deleting an unstable target when the unstable target is generated; and
selecting one of the process of holding the target and the process of deleting the unstable target.

11. A program causing a computer to execute the steps of:
detecting light corresponding to a plurality of operation inputs to a display screen displaying an image from an outside;
generating information of a target indicating a series of inputs on the basis of a temporal or spatial positional relation of input portions having been subjected to the input from the outside;
holding a lost target when the generated target is temporarily lost;
deleting an unstable target when the unstable target is generated; and
selecting one of the process of holding the target and the process of deleting the unstable target.

12. An operation input device comprising:
an input and output unit configured to detect light corresponding to a plurality of operation inputs to a display screen displaying an image from an outside;
a target generating unit configured to generate information of a target indicating a series of inputs on the basis of a temporal or spatial positional relation of input portions having been subjected to the input from the outside;
a lost data holding unit configured to hold a lost target when the target generated by the target generating unit is temporarily lost;
an unreliable data deleting unit configured to delete an unstable target when the unstable target is generated by the target generating unit; and
a process selecting unit configured to select one of a process performed by the lost data holding unit and a process performed by the unreliable data deleting unit.
